(19) United States
(12) Patent Application Publication
(10) Pub. No.: US 2012/0202030 A1
(43) Pub. Date: Aug. 9, 2012

(54) GLASS LAMINATE, DISPLAY DEVICE PANEL WITH SUPPORTING BODY, DISPLAY DEVICE PANEL, DISPLAY DEVICE, METHOD FOR PRODUCING GLASS LAMINATE, METHOD FOR PRODUCING DISPLAY DEVICE PANEL WITH SUPPORTING BODY, AND METHOD FOR PRODUCING DISPLAY DEVICE PANEL

(75) Inventors: Satoshi KONDO, Tokyo (JP); Motoshi ONO, Tokyo (JP); Sohei KAWANAMI, Tokyo (JP)

(73) Assignee: Asahi Glass Company, Limited

(21) Appl. No.: 13/451,508

(22) Filed: Apr. 19, 2012

Related U.S. Application Data
(63) Continuation of application No. PCT/JP2010/067899, filed on Oct. 12, 2010.

(30) Foreign Application Priority Data
Oct. 20, 2009 (JP) 2009-241384

(51) Int. Cl. B32B 17/06; B32B 37/00; B32B 7/02; B32B 27/40; B32B 17/10

(52) U.S. Cl. 428/215; 428/425.6; 428/429; 428/441; 156/60; 156/272.8; 156/247

(57) ABSTRACT

The present invention relates to a glass laminate including: a thin glass substrate having a first main surface and a second main surface; a supporting glass substrate having a first main surface and a second main surface, provided such that the first main surface thereof faces the first main surface of the thin glass substrate; a resin layer formed between the thin glass substrate and the supporting glass substrate, fixed to the first main surface of the supporting glass substrate and closely adhered to the first main surface of the thin glass substrate with peelability to the first main surface thereof; and an outer frame layer containing a glass sealing material and being formed by firing at an outer side of a peripheral part of the resin layer.

### TECHNICAL FIELD

The present invention relates to a glass laminate, a support-attached panel for a display device, a panel for a display device, a display device, and methods for producing those.

### BACKGROUND ART

In the field of display devices such as liquid crystal displays (LCD) and organic EL displays (OLED), particularly portable displays such as a digital camera and cellular telephone, reduction of the weight and thickness of display devices is an important problem.

For solving this problem, it is desired to further reduce the thickness of a glass substrate used in a display device. As a method of reducing the thickness, a method is generally used in which after forming a member for a display device on the surface of a glass substrate to form a panel for a display device, both outer surfaces of the panel for a display device are subjected to etching treatment using chemical etching, thereby reducing the thickness of the panel for a display device.

In the method of reducing the thickness of a substrate by chemical etching, for example, in the case of reducing the thickness of one glass substrate from 0.7 mm to 0.2 mm or 0.1 mm, most original material of the substrate is scraped off by an etching liquid. This is not preferred in the standpoints of productivity and efficiency in the use of raw materials. On the other hand, in the case where it intends to produce a TFT array substrate and a color filter substrate by employing a glass substrate having small thickness from the beginning, strength of the glass substrate at the production is insufficient, and an amount of deflection is increased. This gives rise to a problem that a glass substrate cannot be treated in the existing production line.

Furthermore, in the method for reducing a thickness of a substrate by chemical etching, the thickness of a glass substrate is reduced by performing chemical etching or the like after forming a member for a display device on the surface of a glass substrate. This may give rise to a problem of manifestation of fine scratches formed on the surface of a glass substrate in a process of forming a member for a display device on the surface of a glass substrate, that is, a problem of generation of etchpits.

With the aim of solving such problems, there are proposed a method in which a glass substrate having small thickness (hereinafter referred to as a “thin glass substrate”) is laminated to other glass substrate (hereinafter referred to as a “supporting glass substrate”) to obtain a laminate, predetermined treatments for the production of a display device are carried out in this state, and the thin glass substrate and the supporting substrate are peeled, and other methods.

For example, Patent Document 1 describes a thin glass laminate including a thin glass substrate and a supporting glass substrate, laminated through a silicone resin layer having easy peelability and non-adhesiveness. Patent Document 1 further describes that in order to peel the thin glass substrate and the supporting glass substrate, force which separates the thin glass substrate from the supporting glass substrate in a vertical direction is given, and a trigger of peeling is formed on the edge by a razor blade, or air is injected in a laminate interface, thereby making it possible to perform easier peeling.

### BACKGROUND ART DOCUMENTS

### Patent Document

Patent Document 1: WO 2007/018028 pamphlet

### SUMMARY OF THE INVENTION

### Problems That the Invention is to Solve

A glass substrate is heat-treated in a process of forming a member for a display device, such as TFT array, on a thin glass substrate.

For example, in the glass substrate described in Patent Document 1, in the case where heat treatment temperature is, for example, high temperature exceeding about 400° C., a part which is the edge of a silicone resin layer and contacts ambient air may be oxidized and deteriorated. In such a case, easy peelability of the silicone resin layer to the thin glass substrate is lost, and additionally, there is a concern that the silicone resin layer peel from the supporting glass substrate. Furthermore, the silicone resin layer whitens by oxidation to generate powdery SiO₂, and the powder may contaminate facilities of a heat treatment step.

Accordingly, the present invention has an object to provide a glass substrate in which a resin layer is difficult to be oxidized even in high temperature heat treatment.

### Means for Solving the Problems

The present inventors have made intensive investigations to solve the above problems. As a result, they have found that a resin layer is difficult to be oxidized even in high temperature heat treatment by forming a glass laminate having an outer frame layer containing a glass sealing material and formed by firing at the outer side of a peripheral part of a resin layer, and have completed the present invention.

Namely, the present invention provides the following items (1) to (17).

(1) A glass laminate comprising:

a thin glass substrate having a first main surface and a second main surface;

a supporting glass substrate having a first main surface and a second main surface, provided such that the first main surface thereof faces the first main surface of the thin glass substrate;

a resin layer formed between the thin glass substrate and the supporting glass substrate, fixed to the first main surface of the supporting glass substrate and closely adhered to the first main surface of the thin glass substrate with peelability to the first main surface thereof; and

an outer frame layer containing a glass sealing material and being formed by firing at an outer side of a peripheral part of the resin layer.

(2) The glass laminate according to item (1), wherein the outer frame layer is formed by firing with laser irradiation.
(3) The glass laminate according to item (2), wherein the glass sealing material has a melting temperature of 400° C. or more and 750° C. or less.
(4) The glass laminate according to any one of items (1) to (3), wherein the outer frame layer has a cross-sectional area S of 3×10⁻⁶ mm²≦S≦5 mm².
(5) The glass laminate according to any one of items (1) to (4), wherein the resin layer contains at least one kind selected from the group consisting of an acrylic resin, a polyolefin resin, a polyurethane resin and a silicone resin.
(6) The glass laminate according to any one of items (1) to (5), wherein the thin glass substrate has a thickness of 0.3 mm or less, and the supporting glass substrate has a thickness of 0.4 mm or more.
(7) A support-attached panel for a display device, comprising: the glass laminate according to any one of items (1) to (6); and a member for a display device, formed on the second main surface of the thin glass substrate in the glass laminate.
(8) A panel for a display device, obtained from the support-attached panel for a display device according to item (7).
(9) A display device comprising the panel for a display device according to item (8).
(10) A method for producing the glass laminate according to any one of items (1) to (6), the method comprising the steps of:

forming the resin layer on the first main surface of the supporting glass substrate and fixing the resin layer to the first main surface of the supporting glass substrate;

applying the glass sealing material to the outer side of the peripheral part of the resin layer fixed to the first main surface of the supporting glass substrate;

closely adhering a peelable surface of the resin surface fixed to the first main surface of the supporting glass substrate to the first main surface of the thin glass substrate; and

firing the glass sealing material applied to the outer side of the peripheral part of the resin layer to form the outer frame layer.

(11) A method for producing the glass laminate according to any one of items (1) to (6), the method comprising the steps of:

applying the glass sealing material to a peripheral part on the first main surface of the supporting glass substrate;

firing the glass sealing material applied to the peripheral part of the first main surface of the supporting glass substrate to form the outer frame layer;

forming the resin layer in an inner region of the outer frame layer formed on the first main surface of the supporting substrate, and fixing the resin layer to the first main surface of the supporting glass substrate; and

closely adhering a peelable surface of the resin layer fixed to the first main surface of the supporting glass substrate to the first main surface of the thin glass substrate.

(12) A method for producing the glass laminate according to any one of items (1) to (6), the method comprising the steps of:

applying the glass sealing material to a peripheral part on the first main surface of the supporting glass substrate;

forming the resin layer in an inner region of the glass sealing material applied to the first main surface of the supporting glass substrate and fixing the resin layer to the first main surface of the supporting glass substrate;

firing the glass sealing material applied to the first main surface of the supporting glass substrate to form the outer frame layer; and

closely adhering a peelable surface of the resin layer fixed to the first main surface of the supporting glass substrate to the first main surface of the thin glass substrate.

(13) A method for producing the glass laminate according to any one of items (1) to (6), the method comprising the steps of:

forming the resin layer on the first main surface of the supporting glass substrate and fixing the resin layer to the first main surface of the supporting glass substrate;

closely adhering a peelable surface of the resin layer to the first main surface of the thin glass substrate;

applying the glass sealing material to the outer side of the peripheral part of the resin layer; and

firing the glass sealing material applied to the outer side of the peripheral part of the resin layer to form the outer frame layer.

(14) The method for producing the glass laminate according to item (13), wherein the outer frame layer is formed by irradiating the glass sealing material with laser.
(15) A method for producing a supported-attached panel for a display device, the method comprising:

the method for producing a glass laminate according to any one of items (10) to (14); and

a step of forming a member for a display device on the second main surface of the thin glass substrate of the glass laminate.

(16) A method for producing a panel for a display device, the method comprising:

the method for producing a support-attached panel for a display device according item (15); and

a peeling step of peeling the thin glass substrate and the supporting glass substrate of the support-attached panel for a display device.

(17) The method for producing a panel for a display device according to item (16), wherein the peeling step is a step of peeling the thin glass substrate and the supporting glass substrate after physically destroying at least a part of the outer frame layer.

### ADVANTAGE OF THE INVENTION

According to the present invention, a glass laminate in which a resin layer is difficult to be oxidized even in high temperature heat treatment can be provided.

### BRIEF DESCRIPTION OF THE DRAWINGS

FIG. 1 is a schematic front view showing one embodiment (Constructive Example 1) of the glass laminate of the present invention.

FIG. 2 is a partial cross-sectional view of Constructive Example 1 taken along A-A′ line in FIG. 1.

FIG. 3 is a partial cross-sectional view showing a sealing part of Modification Example 1.

FIG. 4 is a partial cross-sectional view showing a sealing part of Modification Example 2.

FIG. 5 is a partial cross-sectional view showing a sealing part of Modification Example 3.

FIG. 6 is a partial cross-sectional view showing a sealing part of Modification Example 4.

FIG. 7 is a flow chart of a first production method according to the present invention.

FIG. 8 is a flow chart of a second production method according to the present invention.

FIG. 9 is a flow chart of a third production method according to the present invention.

FIG. 10 is a flow chart of a fourth production method according to the present invention.

### MODE FOR CARRYING OUT THE INVENTION

### <Glass Laminate>

The glass laminate of the present invention includes a thin glass substrate having a first main surface and a second main surface; a supporting glass substrate having a first main surface and a second main surface, provided such that the first main surface thereof faces the first main surface of the thin glass substrate; a resin layer formed between the thin glass substrate and the supporting glass substrate, fixed to the first main surface of the supporting glass substrate and closely adhered to the first main surface of the thin glass substrate with peelability to the first main surface thereof; and an outer frame layer containing a glass sealing material and formed by firing at an outer side of a peripheral part of the resin layer.

The mode for carrying out the glass laminate of the present invention is described below by reference to the drawings. The term “glass laminate” is hereinafter sometimes referred to as a “laminate” for simplicity.

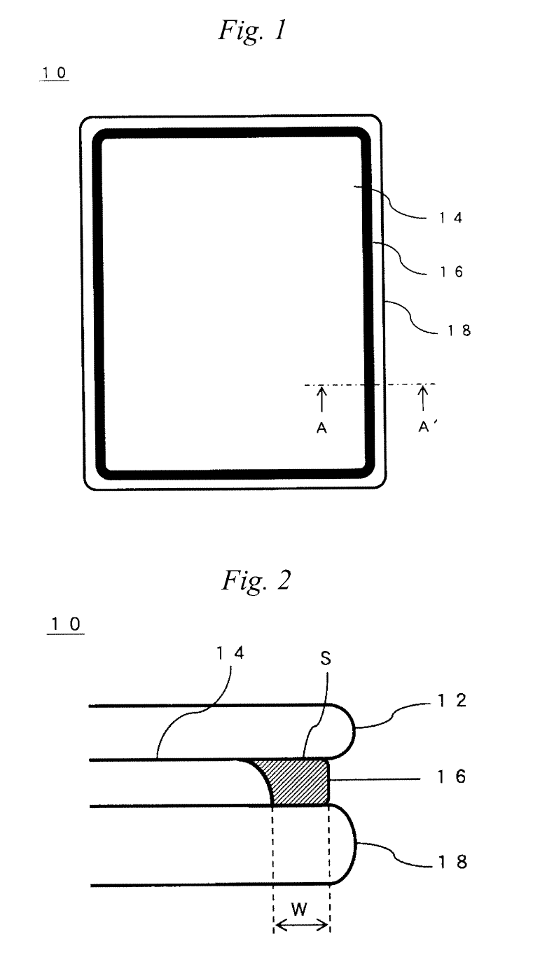

FIG. 1 is a schematic front view showing one embodiment (Constructive Example 1) of the glass laminate of the present invention. FIG. 2 is a partial cross-sectional view taken along A-A′ line in FIG. 1. In a laminate 10, a resin layer 14 is formed in the central part of a first main surface of a supporting glass substrate 18, and an outer frame layer 16 is formed at the outer side of a peripheral part of the resin layer 14.

In the laminate 10, a thin glass substrate 12 and a supporting glass substrate 18 are laminated through the resin layer, and the outer frame layer 16 is formed at the outer side of the peripheral part of the resin layer 14. In this case, the thin glass substrate 12 and the supporting glass substrate 18 have nearly the same shape. Those substrates are laminated so as to be seen such that an outer edge of the thin glass substrate 12 and an outer edge of the supporting glass substrate 18 are overlapped when viewing the laminate 10 from the front (for example, the case as shown in FIG. 1). Therefore, the thin glass substrate 12 shown in FIG. 2 is omitted in FIG. 1 from the indication. The glass laminate having the constitution is hereinafter referred to as an “embodiment 1”.

In general, a glass substrate is chamfered after cutting in order to hold its edge strength. For this reason, the edge shape of the thin glass substrate 12 and the supporting glass substrate 18 are indicated in an arc shape in the drawings.

The outer side of a peripheral part of the resin layer means a region on the first main surface of the supporting glass substrate and included in the outer side than the outer edge of the resin layer 14 in the case of viewing the glass substrate from the front (for example, the case as shown in FIG. 1), and further means a region near the outer edge of the supporting glass substrate, in the embodiment 1, and embodiments 2 and 3 described hereinafter.

In embodiments 4 and 5 described hereinafter, the outer side of a peripheral part of the resin layer means a region on the edge of the resin layer and outside than the outer edge of the resin layer.

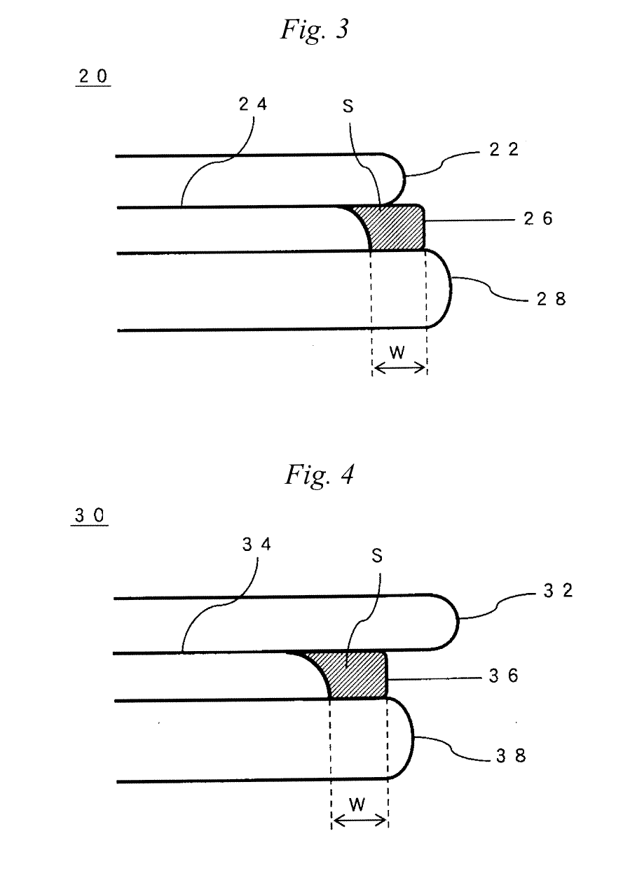

FIG. 3 is a partial cross-sectional view showing Modification Example 1 of Constructive Example 1. In a laminate 20 shown in FIG. 3, a thin glass substrate 22 and a supporting glass substrate 28 are laminated through a resin layer 24, and an outer frame layer 26 is formed at the outer side of a peripheral part of the resin layer 24. In this case, the supporting glass substrate 28 is larger than the thin glass substrate 22. The glass laminate having the constitution is hereinafter referred to as an “embodiment 2”.

FIG. 4 is a partial cross-sectional view of Modification Example 2 having a structure different from that of FIG. 3. In a laminate 30, a thin glass substrate 32 and a supporting glass substrate 38 are laminated through a resin layer 34, and an outer frame layer 36 is formed at the outer side of a peripheral part of the resin layer 34. In this case, the supporting glass substrate 38 is smaller than the thin glass substrate 32. The glass laminate having the constitution is hereinafter referred to as an “embodiment 3”.

In the embodiment 1 to 3, a width W of the outer side of a peripheral part of the resin layer on which an outer frame layer is formed is preferably from 0.5 to 100 mm, more preferably from 0.5 to 50 mm, more preferably from 0.5 to 10 mm, and further preferably from 0.5 to 5 mm, inside from an outer edge of a first main surface of the supporting glass substrate. In the case where the supporting glass substrate is large, the width W may be large.

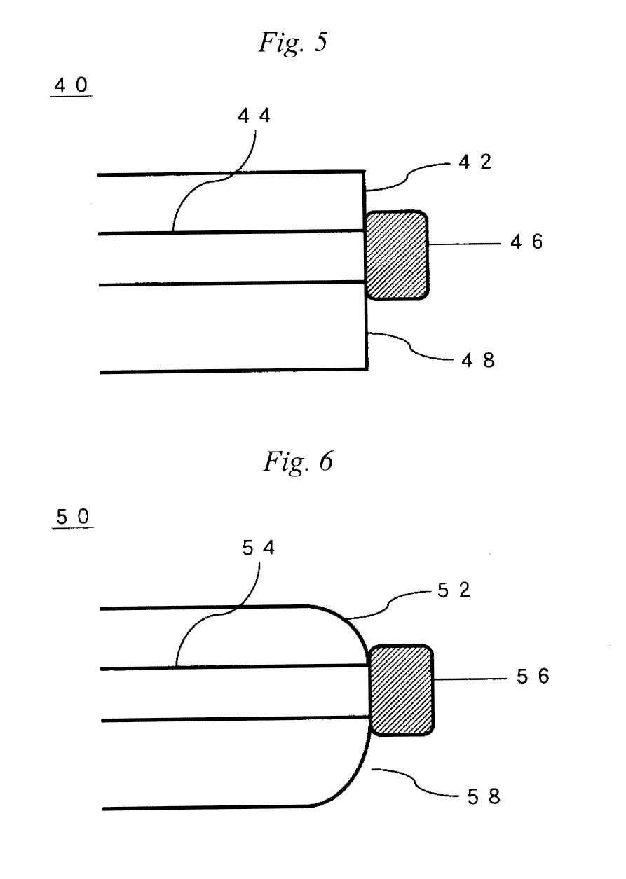

FIG. 5 is a partial cross-sectional view of Modification Example 3 having a structure different from that of FIG. 2. The embodiments 1 to 3 are that a resin layer is formed on a supporting glass substrate having a predetermined size, and furthermore, a thin glass substrate having a predetermined size is laminated. On the other hand, in Modification Example 3 shown in FIG. 5, the edge of a laminate previously laminated is cut, and an outer frame layer is then formed at the outer side of a peripheral part of the resin layer. The glass laminate having the constitution is hereinafter referred to as an “embodiment 4”.

In a laminate 40 in the embodiment 4, a thin glass substrate 42 and a supporting glass substrate 48 are laminated through a resin layer 44, and an outer frame layer 46 is formed at the outer side of a peripheral part of the resin layer 44. Edge strength of the thin glass substrate 42 and the supporting glass substrate 48 is secured to some extent by formation of the outer frame layer 46.

FIG. 6 is a partial cross-sectional view of Modification Example 4 having a structure different from that of FIG. 5. Similar to the embodiment 4, the edge of a laminate previously laminated is cut, and an outer frame layer is then formed at the outer side of a peripheral part of a resin layer. However, before forming the outer frame layer, a thin glass substrate and a supporting glass substrate are chamfered. The glass substrate having the constitution is hereinafter referred to as an “embodiment 5”.

In a laminate 50 in the embodiment 5, a thin glass substrate 52 and a supporting glass substrate 58 are laminated through a resin layer 54, and an outer frame layer 56 is formed at the outer side of a peripheral part of the resin layer 54.

In the embodiments 1 to 5, the resin layer is fixed to the first main surface of the supporting glass substrate and is closely adhered to the thin glass substrate, with peelability to the first main surface of the thin glass substrate.

In the embodiments 1 to 5, the resin layer is isolated from the contact with the ambient air by the outer frame layer. As a result, the glass laminates of the embodiments 1 to 5 are difficult to generate a gas. Specifically, because the outer frame layer is present, a gas generated from the resin layer is not discharged to the outside.

Furthermore, the glass laminates of the embodiments 1 to 5 are that the resin layer between the thin glass substrate and the supporting glass substrate is difficult to be oxidized and deteriorated even though the heat treatment temperature is relatively high temperature (exceeding about 400° C.). The reason for this is that the outer frame layer blocks the contact between the ambient air and the edge of the resin layer.

Next, the thin glass substrate, supporting glass substrate, resin layer and outer frame layer constituting the laminate of the present invention are described below.

### <Thin Glass Substrate>

The thickness, shape, size, physical properties (heat shrinkage ratio, surface form, chemical resistance and the like), composition and the like of the thin glass substrate are not particularly restricted, and for example, may be the same as those of conventional glass substrates for displays, such as LCD, OLED and the like.

The thickness of the thin glass substrate is not particularly restricted as described above, and is preferably 0.3 mm or less, and more preferably 0.2 mm or less. On the other hand, the thickness is preferably 0.05 mm or more, more preferably 0.07 mm or more, and further preferably 0.1 mm or more.

The shape of the thin glass substrate is not particularly restricted as described above, and is preferably a rectangle form. The term “rectangle form” used herein includes forms that are substantially an approximate rectangle and in which corners of a peripheral part are cut (corner cut).

The size of the thin glass substrate is not restricted as described above. For example, in the case of a rectangle, the size is preferably 100 to 2,000 mm×100 to 2,000 mm, and more preferably 500 to 1,000 mm×500 to 1,000 mm.

The thickness and size of the thin glass substrate are represented by an average value of values obtained by measuring in-plane 9 points using a laser focus displacement meter, and the size means values obtained by measuring the short side and the long side using a steel rule. The thickness and size of the supporting glass substrate described hereinafter are the same as above.

Even though the thin glass substrate has the thickness and size as above, the thin glass substrate and the supporting glass substrate can be easily peeled in the laminate of the present invention.

The physical properties of the thin glass substrate are not restricted as described above. Although varying depending on the kind of a display device to be produced, it is preferably that the thin glass substrate has small heat shrinkage ratio. Specifically, the linear expansion coefficient as an index of heat shrinkage ratio is preferably 500×10⁻⁷/° C. or less, more preferably 300×10⁻⁷/° C. or less, more preferably 200×10⁻⁷/° C. or less, more preferably 100×10⁻⁷/° C. or less, and further preferably 45×10⁻⁷/° C. or less. In the case that the heat shrinkage ratio is large, a highly precise display device cannot be fabricated. The linear expansion coefficient is according to JIS R3102-1995.

The composition of the thin glass substrate is not restricted as described above. Glasses having various compositions, such as a glass containing an alkali metal oxide (soda lime glass or the like) and a non-alkali glass, can be used. Of those, the non-alkali glass is preferable because of its small heat shrinkage ratio.

### <Supporting Glass Substrate>

The thickness, shape, size, physical properties (heat shrinkage ratio, surface form, chemical resistance and the like), composition and the like of the supporting glass substrate are not particularly restricted.

The thickness of the supporting glass substrate is not particularly restricted as described above. The thickness is preferably a thickness that can be treated with the existing production line.

Specifically, it is preferable that the thickness is 0.4 mm or more. For example, the thickness is preferably from 0.4 to 1.1 mm, more preferably from 0.5 to 0.8 mm, and further preferably from 0.5 to 0.7 mm.

For example, in the case that the existing production line is designed so as to treat a glass substrate having a thickness of 0.5 mm, and the thickness of the thin glass substrate is 0.1 mm, the sum of the thickness of the supporting glass substrate and the thickness of the resin layer is 0.4 mm. Furthermore, it is most general that the existing display device production line is designed so as to treat a glass substrate having a thickness of 0.7 mm. For example, when the thickness of the thin glass substrate is 0.3 mm, the sum of the thickness of the supporting glass substrate and the thickness of the resin layer is 0.4 mm.

The thickness of the supporting glass substrate is preferably larger than that of the thin glass substrate in order to support the thin glass substrate and reinforce strength of the thin glass substrate.

The shape of the supporting glass substrate is not particularly restricted, and is preferably a rectangle form. The term “rectangle form” used herein includes forms that are substantially approximate rectangle and in which peripheral corners are cut (corner cut).

The linear expansion coefficient of the supporting glass substrate may be substantially the same as that of the thin glass substrate or may be different from that of the thin glass substrate. When the linear expansion coefficient is substantially the same, it is preferred in that warpage is difficult to be generated in the thin glass substrate or the supporting glass substrate when heat-treating the laminate of the present invention.

The difference in the linear expansion coefficient between the thin glass substrate and the supporting glass substrate is preferably 300×10⁻⁷/° C. or less, more preferably 100×10⁻⁷/° C. or less, and further preferably 50×10⁻⁷/° C. or less. The thin glass substrate and the supporting glass substrate may be glasses including the same materials. In this case, the difference in the linear expansion coefficient between those glasses is 0.

The composition of the supporting glass substrate may be the same as that of, for example, an alkali glass and a non-alkali glass. Of those, the non-alkali glass is preferred because of its small heat shrinkage ratio.

Methods for producing the thin glass substrate and the supporting glass substrate are not particularly restricted, and can use the conventionally known methods. For example, the thin glass substrate and the supporting glass substrate can be obtained by melting the conventionally known raw materials to obtain a molten glass, and molding the molten glass into a plate form by a float process, a fusion process, a drawing process, a slot down drawing process, a redrawing process or the like.

The surface of the thin glass substrate and the supporting glass substrate may be a polished surface which has been subjected to a polishing treatment, or may be a non-etched surface (raw surface) which has not been subjected to a polishing treatment. Non-etched surface (raw surface) is preferred from the points of productivity and costs.

### <Resin Layer>

The resin layer is fixed to the first main surface of the supporting glass substrate. On the other hand, the resin layer is closely adhered to the first main surface of the thin glass substrate, but can be easily peeled. That is, the resin layer binds to the first main surface of the thin glass substrate with certain binding force to such an extent that the resin layer can be easily peeled without giving unfavorable influences to the thin glass substrate in peeling. For this reason, in peeling, the thin glass substrate is not damaged, and residual adhesive is not present on the first main surface of the thin glass substrate. The easily peelable nature on the surface of the resin layer is called peelability. Furthermore, the resin layer surface is hereinafter sometimes called peelable surface.

It is preferable that the resin layer and the first main surface of the thin glass substrate are not attached to each other with a pressure-sensitive adhesive force as manifested by a pressure-sensitive adhesive, and are attached to each other with force ascribable to van der Waals force between solid molecules, that is, with close adhesion force.

On the other hand, the bonding force of the resin layer to the first main surface of the supporting glass substrate is relatively higher than the bonding force to the first main surface of the thin glass substrate. In the present invention, the bond to the first main surface of the thin glass substrate is called close adhesion, and the bond to the first main surface of the supporting glass substrate is called fixing.

The thickness of the resin layer is not particularly restricted, and is preferably from 1 to 100 μm, more preferably from 5 to 30 μm, and further preferably from 7 to 20 μm. When the thickness of the resin layer is in the range, close adhesion between the thin glass substrate and the resin layer becomes sufficient. Furthermore, even where gas bubbles and foreign matters are included, occurrence of deformation defects can be suppressed in the thin glass substrate. Where the thickness of the resin layer is too large, much formation time and a large amount of materials are required, and this is not economical.

The thickness of the resin layer means an average value of values obtained by measuring in-plane 9 points using a laser focus displacement meter. The thickness of the outer frame layer described hereinafter is the same as above.

The resin layer may include two layers or more. In this case, the “thickness of the resin layer” means the total thickness of all of layers.

Where the resin layer includes two layers or more, the kind of a resin constituting each layer may differ. The same is applied to the outer frame layer described hereinafter.

The surface tension on the peelable surface of the resin layer is preferably 30 mN/m or less, more preferably 25 mN/m or less, and further preferably 22 mN/m or less. In the case where the surface tension is in the range, the resin layer can be easily peeled from the thin glass substrate, and simultaneously, close adhesion to the thin glass substrate becomes sufficient.

The material of the resin layer is preferably a material having a glass transition point lower than room temperature (about 25° C.) or a material which does not have a glass transition point. The reason for this is that the material forms a non-pressure-sensitive resin layer, such a resin layer has higher peelability and can be easily peeled from the thin glass substrate surface, and at the same time, close adhesion to the thin glass substrate surface becomes sufficient.

It is preferable that the resin layer has heat resistance. For example, in the case of forming a member for a display device on the second main surface of the thin glass substrate, the laminate of the present invention can be subjected to heat treatment.

Too high elastic modulus of the resin layer tends to decrease close adhesion to the thin glass substrate surface, and this is not preferred. On the other hand, the elastic modulus of the resin layer is too low, peelability is decreased.

The resin constituting the resin layer is not particularly restricted, and examples thereof include an acrylic resin, a polyolefin resin, a polyurethane resin and a silicone resin. Those resins can be used as mixtures of two or more thereof.

The resin constituting the resin layer is not particularly restricted as described above, but a silicone resin is preferred for the reasons that the silicone resin has excellent heat resistance and has excellent peelability of the thin glass substrate. The silicone resin is further preferred from the point that even though treated, for example, at about 400° C. for about 1 hour, peelability is not almost deteriorated.

In the case that the silicone resin is cured on the first main surface of the supporting glass substrate to form a silicone resin layer, the silicone resin is preferred from the point that the resin layer is easily fixed to the supporting glass substrate by condensation reaction to a silanol group on the surface of the supporting glass substrate.

Of the silicone resin, silicone for a release paper is preferred. The silicone for a release paper includes silicone containing a linear dimethylpolysiloxane in the molecule as a base compound. The resin layer formed by curing the composition containing the base compound and a cross-linking agent on the first main surface of the supporting glass substrate using a catalyst, a photopolymerization initiator or the like has excellent peelability and is therefore preferred. Furthermore, the silicone has high flexibility. Therefore, even though gas bubbles, dusts and the like are incorporated between the thin glass substrate and the resin layer, only the resin layer deforms. As a result, occurrence of deformation defects can be suppressed in the thin glass substrate, and this is preferred.

Silicones for a release paper are classified into condensation reaction type silicone, addition reaction type silicone, ultraviolet curing silicone and electron beam curing silicone, depending on the curing mechanism. Any of the silicones for a release paper can be used. Of those, the addition reaction type silicone is preferred. The reason for this is that curing reaction easily proceeds, the extent of peelability when a resin layer has been formed is good, and heat resistance is high.

The form of the silicone for a release paper includes a solvent type, an emulsion type and a non-solvent type. Any type of the silicone for a release paper can be used.

Trade names and model numbers commercially available as silicones for a release paper specifically include KNS-320A and KS-847 (manufactured by Shin-Etsu Silicone Co., Ltd.), TPR6700 (manufactured by Toshiba Silicone Co., Ltd.), a combination of vinylsilicone “8500” (manufactured by Arakawa Chemical Industries, Ltd.) and methylhydrogen polysiloxane “12031” (manufactured by Arakawa Chemical Industries, Ltd.), a combination of vinylsilicone “11364” (manufactured by Arakawa Chemical Industries, Ltd.) and methylhydrogen polysiloxane “12031 (manufactured by Arakawa Chemical Industries, Ltd.), and a combination of vinylsilicone “11365” (manufactured by Arakawa Chemical Industries, Ltd.) and methylhydrogen polysiloxane “12031” (manufactured by Arakawa Chemical Industries, Ltd.).

KNS-320A, KS-847 and TPR6700 previously contain a base compound and a crosslinking agent.

Furthermore, the silicone resin preferably has a property that components in the silicone resin are difficult to migrate in the thin glass substrate, that is, has low silicone migration property.

### (Outer Frame Layer)

The outer frame layer has a band shape, and is present at the peripheral part of the laminate of the present invention. The outer frame layer is formed so as to surround the resin layer, and must basically be formed continuously.

However, in the case that the laminate is heated at ultrahigh temperature (600° C. or higher) for a long period of time, it is considered that the resin layer causes decomposition reaction. Therefore, to prevent peeling of supporting glass substrate/thin glass substrate due to increase in inner pressure of the laminate, portions on which the outer frame layer is not partially formed may be provided.

The outer frame layer preferably contacts both the supporting glass substrate and the thin glass substrate in its formation portion. This constitution makes the resin layer difficult to contact the ambient air.

The cross-sectional shape of the outer frame layer is not particularly restricted. However, the outer frame layer is required to block the contact between the resin layer and the ambient air. Therefore, the outer frame layer is required to have a cross-sectional area S having a given size.

The term “cross-sectional area S” of the outer frame layer means a cross-sectional area of the outer frame layer present at the edge of the laminate of the present invention when viewing the cross-section of the laminate of the present invention from its in-plane direction.

The cross-sectional area S is preferably 3×10⁻⁶ mm² or more, and more preferably 3×10⁻⁴ mm² or more in order to surely block from the ambient air.

In the case where the cross-sectional area S is too large, peeling strength becomes too large in peeling the supporting glass substrate and the thin glass substrate. For this reason, the cross-sectional area S is preferably 5 mm² or less, and more preferably 1 mm² or less in order to facilitate peeling.

The outer frame layer contains a glass sealing material to be fired. That is, the outer frame layer is a fired layer of the glass sealing material.

The glass sealing material has low mass loss ratio even though high temperature treatment is applied, and further has blocking property of a gas which may possibly be generated from the resin layer.

The glass sealing material is prepared by blending a laser absorber or a filler such as a low expansion filler with a sealing glass which is a main component. The glass sealing material may further contain other additives, if necessary.

A low melting glass such as tin-phosphate glass, bismuth glass, vanadium glass or lead glass is used as the sealing glass (glass frit).

Of those, considering sealability (adhesiveness) to the thin glass substrate and the supporting glass substrate, its reliability (adhesion reliability and airtight property), influence to environment and human body, and the like, tin-phosphate glass and bismuth glass are preferably used.

The tin-phosphate glass (frit glass) preferably has a composition of 20 to 68 mass % SnO, 0.5 to 5 mass % SnO₂ and 20 to 40 mass % P₂O₅ (basically, the total amount is 100 mass %).

SnO is a component for decreasing a melting point of a glass. In the case where the SnO content is less than 20 mass %, viscosity of a glass is increased, and a sealing temperature becomes too high. In the case where the SnO content exceeds 68 mass %, vitrification does not occur.

SnO₂ is a component for stabilizing a glass. In the case where the SnO₂ content is less than 0.5 mass %, SnO₂ is separated and precipitated in a glass softened and melted in a sealing work, fluidity is deteriorated, and sealing workability is decreased. In the case where the SnO₂ content exceeds 5 mass %, SnO₂ is easily precipitated during melting a low melting glass.

P₂O₅ is a component for forming a glass skeleton. In the case where the P₂O₅ content is less than 20 mass %, vitrification does not occur. In the case where the content exceeds 40 mass %, deterioration of weatherability which is an inherent defect of phosphate glass may occur.

Proportions (mass %) of SnO and SnO₂ in a glass frit can be obtained as follows. A glass fit is acid-decomposed, and the total amount of Sn atoms contained in the glass frit is measured with ICP spectroscopic analysis. Next, Sn²⁺ (SnO) is obtained by subjecting the acid-decomposed product to iodine titration method. Sn⁴⁺ (SnO₂) is obtained by subtracting the Sn²⁺ amount obtained, from the total amount of Sn atoms.

A glass formed by the above three components has low glass transition point and is suitable for use as a low temperature sealing material. The glass may further contain components that form a skeleton of a glass, such as SiO₂; components that stabilize a glass, such as ZnO, B₂O₃, Al₂O₃, WO₃, MoO₃, Nb₂O₅, TiO₂, ZrO₂, Li₂O, Na₂O, K₂O, Cs₂O, MgO, CaO, SrO and BaO; and the like, as optional components.

However, in the case where the content of the optional components is too large, a glass becomes unstable, and as a result, devitrification may occur or a glass transition point and a softening point may be increased. Therefore, the total content of the optional components is preferably 30 mass % or less. The glass composition in this case is adjusted such that the total amount of the basic components and the optional components is basically 100 mass %.

The bismuth glass (glass frit) preferably has a composition of 70 to 90 mass % Bi₂O₃, 1 to 20 mass % ZnO and 2 to 12 mass % B₂O₃ (basically the total amount is 100 mass %).

Bi₂O₃ is a component of forming a network of a glass. In the case where the Bi₂O₃ content is less than 70 mass %, a softening point of a low melting glass is increased, and it becomes difficult to perform sealing at low temperature. In the case where the Bi₂O₃ content exceeds 90 mass %, vitrification is difficult to occur, and additionally, a thermal expansion coefficient tends to be too much increased.

ZnO is a component of decreasing a thermal expansion coefficient and the like. In the case where the ZnO content is lower than 1 mass %, vitrification is difficult to occur. In the case where the ZnO content exceeds 20 mass %, stability when forming a low meting glass is decreased, and devitrification easily occurs.

B₂O₃ is a component of forming a skeleton of a glass to expand a vitrifiable range. In the case where the B₂O₃ content is less than 2 mass %, vitrification becomes difficult. In the case where the B₂O₃ content exceeds 12 mass %, a softening point becomes too high, and it becomes difficult to perform sealing at low temperature even though load is applied when sealing.

The glass formed of the above three components has low glass transition point and is suitable for use as a sealing material at low temperature. The glass may further contain optional components such as Al₂O₃, CeO₂, SiO₂, Ag₂O, MoO₃, Nb₂O₃, Ta₂O₅, Ga₂O₃, Sb₂O₃, Li₂O, Na₂O, K₂O, Cs₂O, CaO, SrO, BaO, WO₃, P₂O₅ and SnOₓ (x is 1 or 2).

However, in the case where the content of the optional components is too large, a glass becomes unstable, and as a result, devitrification may occur or a glass transition point and a softening point may be increased. Therefore, the total content of the optional components is preferably 30 mass % or less. The glass composition in this case is adjusted such that the total amount of the basic components and the optional components is basically 100 mass %.

Laser absorber is an essential component in the case that a glass sealing material is molten by heating with laser light.

The laser absorber uses compounds such as at least one metal selected from Fe, Cr, Mn, Co, Ni and Cu, and oxides containing the metals. Pigments other than those may be used.

The laser absorber content is preferably a range of from 2 to 10 vol % to the glass sealing material. In the case where the laser absorber content is less than 2 vol %, a sealing material layer may not sufficiently be molten when laser irradiation. This may cause poor adhesion. On the other hand, in the case where the laser absorber content exceeds 10 vol %, heat is locally generated in the vicinity of an interface between the thin glass substrate and the supporting glass substrate when laser irradiation, cracks occur in the thin glass substrate and the supporting glass substrate, or fluidity of a glass sealing material is deteriorated when melting, thereby adhesiveness between the thin glass substrate and the supporting glass substrate may be decreased.

Low expansion filler preferably uses at least one selected from silica, alumina, zirconia, zirconium silicate, cordierite, zirconium phosphate compound, soda lime glass and borosilicate glass. The zirconium phosphate compound includes (ZrO)₂P₂O₇, NaZr₂(PO₄)₃, KZr₂(PO₄)₃, Ca_{0.5}Zr₂(PO₄)₃, NaZr(PO₄)₃, Zr₂(WO₃)(PO₄)₂, and those composite compounds.

The low expansion filler has a thermal expansion coefficient lower than that of the sealing glass.

In forming the outer frame layer, for example, a vehicle is mixed with a glass sealing material in which the total content of the low expansion filler and the laser absorber is a range of from 2 to 44 vol %, to prepare a glass sealing material paste.

The vehicle used specifically includes solutions obtained by dissolving methyl cellulose, ethyl cellulose, carboxymethyl cellulose, oxyethyl cellulose, benzyl cellulose, propyl cellulose, nitrocellulose and the like in solvents such as terpineol, butyl carbitol acetate, and ethyl carbitol acetate; and solutions obtained by dissolving acrylic resins such as methyl (meth)acrylate, ethyl (meth)acrylate, butyl (meth)acrylate and 2-hydroxyethyl (meth)acrylate in solvents such as methyl ethyl ketone, terpineol, butyl carbitol acetate, and ethyl carbitol acetate.

The viscosity of the glass sealing material paste is adjusted to a viscosity corresponding to a device to be coated, and can be adjusted by the proportion between a resin as a binder component and a solvent, the proportion between a glass sealing material and a vehicle, and the like. The glass sealing material paste may further contain conventional additives in a glass paste, such as a defoaming agent and a dispersing agent. The preparation of the glass sealing material paste can apply the conventional methods using a rotary mixing machine equipped with stirring wings, roll mill, ball mill, or the like.

The melting temperature of the glass sealing material thus obtained is preferably 400° C. or higher and 750° C. or lower, and more preferably 500° C. or higher and 700° C. or lower. The thermal expansion coefficient of the outer frame layer containing the glass sealing material after firing is preferably from 20×10⁻⁷ to 250×10⁻⁷/° C.

### <Support-attached Panel for Display Device>

The support-attached panel for a display device of the present invention further has a member for a display device on the second main surface of the thin glass substrate in the laminate of the present invention.

The support-attached panel for a display device can be obtained by forming a member for a display device on the second main surface of the thin glass substrate in the laminate of the present invention.

The member for a display device means a light emitting layer, a protective layer, TFT array, a color filter, a liquid crystal, a transparent electrode including ITO, various circuit patterns, and the like, that are present on a surface of the conventional glass substrate for a display device, such as LCD and OLED.

The support-attached panel for a display device of the present invention is preferably that TFT array (hereinafter simply referred to as an “array”) is formed on the second main surface of the thin glass substrate in the laminate of the present invention.

The support-attached panel for a display device of the present invention includes, for example, a panel that other glass substrate (for example, a glass substrate having a thickness of 0.3 mm or more) having formed thereon a color filter is further adhered to the support-attached panel for a display device of the present invention, in which an array is formed on the second main surface of the thin glass substrate.

The “support” in the present invention means a supporting glass substrate having a resin layer fixed to a first main surface thereof

### <Panel for Display Device>

A panel for a display device can be obtained from the support-attached panel for a display device. A panel for a display device having a member for a display device and a thin glass substrate can be obtained from the support-attached panel for a display device by peeling a resin layer fixed to the thin glass substrate and the supporting glass substrate by a method described hereinafter.

### <Display Device>

A display device can be obtained from the panel for a display device. A display device can be obtained by attaching a polarizing plate, a backlight, a panel driving device for a display device, and the like to the panel for a display device. That is, the display device of the present invention is equipped with the panel for a display device. As the display device, LCD and OLED may be mentioned. Examples of the LCD include TN type, STN type, FE type, TFT type, MIM type, VA type and IPS type.

### <Method for Producing Glass Laminate>

Although a method for producing the glass laminate of the present invention is not particularly restricted, methods for producing a glass laminate described below (hereinafter simply referred to as a “production method”) can be selected according to the embodiments 1 to 5 described above.

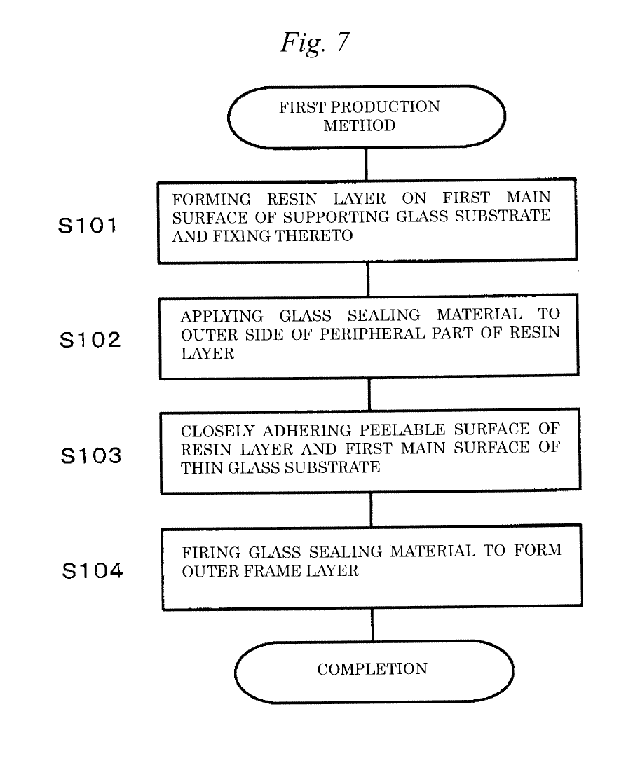

A first production method includes a step of forming a resin layer on a first main surface of a supporting glass substrate and fixing the resin layer to the first main surface (step S101), a step of applying a glass sealing material to the outer side of a peripheral part of the resin layer fixed to the first main surface of the supporting glass substrate (step S102), a step of closely adhering a peelable surface of the resin surface fixed to the first main surface of the supporting glass substrate to a first main surface of a thin glass substrate (step S103), and a step of firing the glass sealing material applied to the outer side of a peripheral part of the resin layer to form an outer frame layer (step S104), as shown in FIG. 7.

The first production method is selected in the productions of the embodiments 1 to 3 described above. The order of the step S103 and the step S104 can be changed.

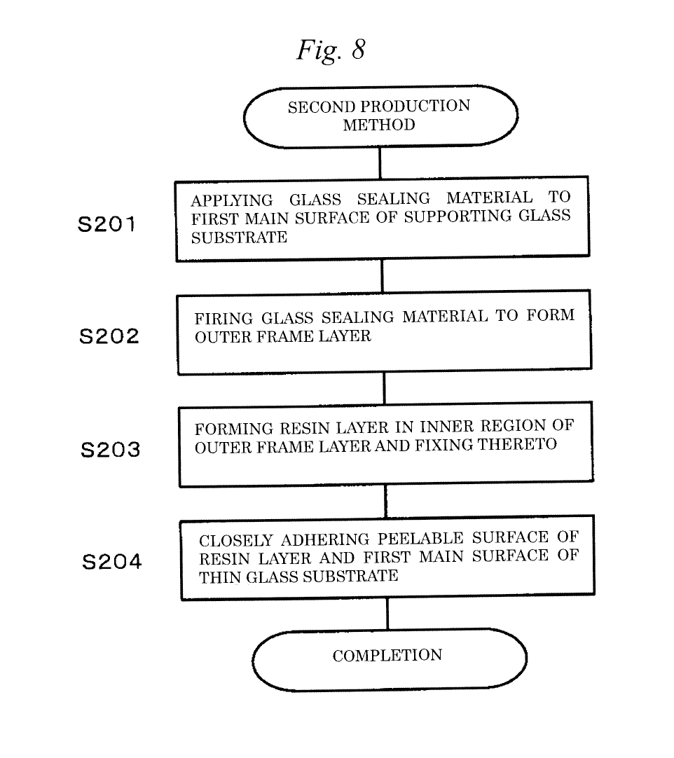

A second production method includes a step of applying a glass sealing material to a peripheral part on a first main surface of a supporting glass substrate (step S201), a step of firing the glass sealing material applied to the peripheral part of the first main surface of the supporting glass substrate to form an outer frame layer (step S202), a step of forming a resin layer in an inner region of the outer frame layer formed on the first main surface of the supporting substrate, and fixing the resin layer to the first main surface (step S203), and a step of closely adhering a peelable surface of the resin layer fixed to the first main surface of the supporting glass substrate to a first main surface of a thin glass substrate (step S204), as shown in FIG. 8.

The second production method is selected in the productions of the embodiments 1 to 3 described above.

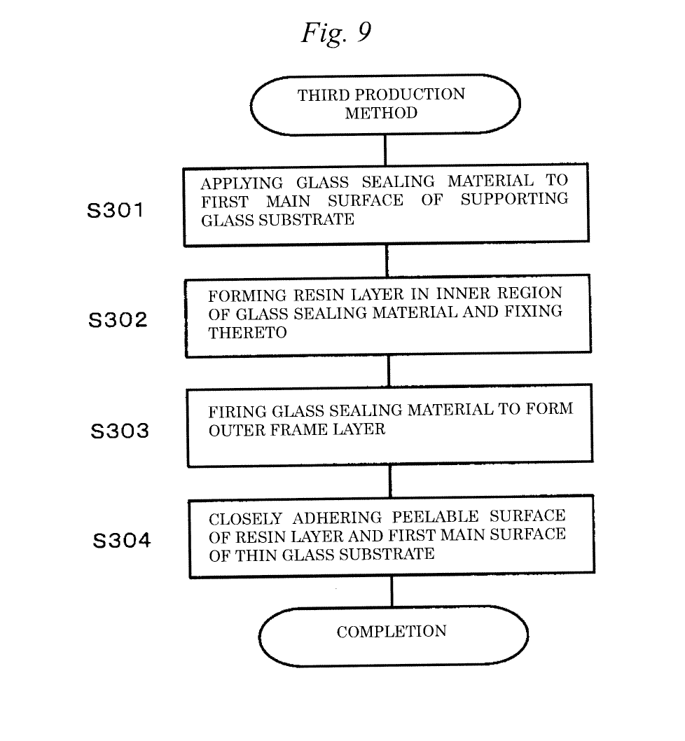

A third production method includes a step of applying a glass sealing material to a peripheral part on a first main surface of a supporting glass substrate (step S301), a step of forming a resin layer in an inner region of the glass sealing material applied to the main surface of the supporting glass substrate and fixing the resin layer to the first main surface (step S302), a step of firing the glass sealing material applied to the first main surface of the supporting glass substrate to form an outer frame layer (step S303), and a step of closely adhering a peelable surface of the resin layer fixed to the first main surface of the supporting glass substrate to a first main surface of a thin glass substrate (step S304), as shown in FIG. 9.

The third production method is selected in the productions of the embodiments 1 to 3 described above.

Furthermore, the third production step may further include a step of calcining the outer frame layer after the step S301 and before the step S302. For example, it is considered that the calcination is conducted in a heating furnace, and firing with laser irradiation is conducted in the step S303.

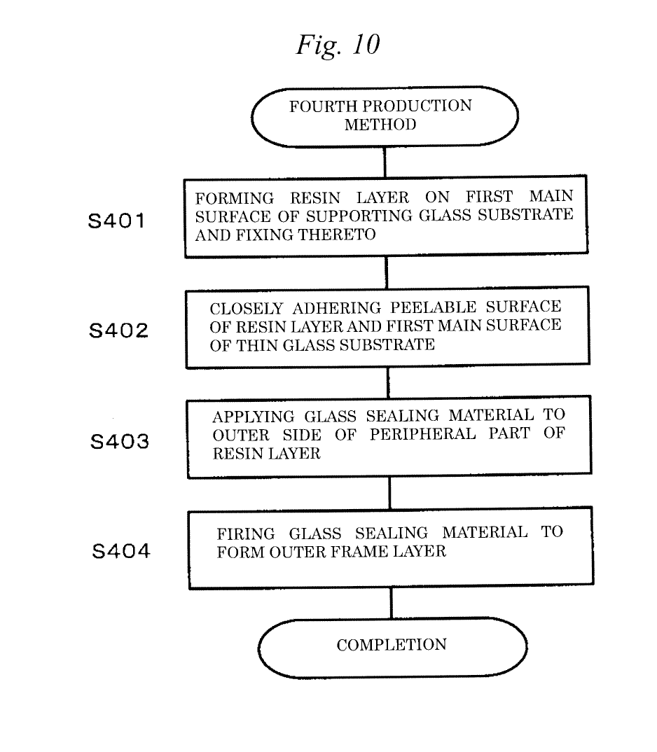

A fourth production step includes a step of forming a resin layer on a first main surface of a supporting glass substrate and fixing the resin layer to the first main surface (step S401), a step of closely adhering a peelable surface of the resin layer to a first main surface of a thin glass substrate (step S402), a step of applying a glass sealing material to the outer side of a peripheral part of the resin layer (step S403), and a step of firing the glass sealing material applied to the outer side of a peripheral part of the resin layer to form an outer frame layer (step S404), and as shown in FIG. 10.

The fourth production method is selected in the productions of the embodiments 1 to 3 described above. The fourth production method further includes a step of cutting an edge of a resulting laminate after the step S402 and before the step S403, and this production method is selected in the production of the embodiment 4 described above. The fourth production method further includes a step of chamfering the thin glass substrate and the supporting glass substrate after the cutting step and before the step S403, and this production method is selected in the production of the embodiment 5 described above.

The content of each step in the first to fourth production methods is described below.

### <Formation of Resin Layer>

The resin layer is formed at a central part on the first main surface of the supporting glass substrate in the first and fourth production methods, and is formed at a central part on the first main surface of the supporting glass substrate and inside the outer frame layer already formed, in the second and third production methods.

A method for forming the resin layer is not particularly restricted. The method includes a method of adhering a film-shaped resin to a surface of a supporting glass substrate, and a method of applying a resin composition becoming a resin layer to a first main surface of a supporting glass substrate by the conventional method and then heat curing.

A method for adhering a film-shaped resin to a surface of a supporting glass substrate specifically includes a method of conducting a surface modification treatment for imparting high adhesive force to a surface of a film and adhering the film to a first main surface of a supporting glass substrate.

The surface modification method includes a chemical method of chemically improving adhesion force using a silane coupling agent or the like, a physical method of increasing surface active groups, such as frame treatment, and a mechanical treatment method of increasing roughness of a surface, such as sandblast treatment, thereby increasing protrusions.

The conventional method used in coating the resin composition includes a spray coating method, a die coating method, a spin coating method, a dip coating method, a roll coating method, a bar coating method, a screen printing method, and a gravure coating method, and can appropriately be selected according to the kind of the resin composition. For example, in the case of using a non-solvent silicone for a release paper as a resin composition, a die coating method, a spin coating method and a screen printing method are preferably used.

The coated amount of the resin composition is preferably from 1 to 100 g/m², and more preferably from 5 to 20 g/m².

For example, a resin composition containing silicone containing linear dimethylpolysiloxane in the molecule (base compound), a crosslinking agent and a catalyst is applied to a first main surface of a supporting glass substrate by the conventional method such as a die coating method, and then heat cured. The resin layer chemically bonds to a first main surface of the supporting glass substrate by heat curing.

The heat curing conditions vary depending on the amount of the catalyst added. For example, in the case that a platinum catalyst is added in an amount of 2 parts by mass per 100 parts by mass of the total amount of the base compound and the crosslinking agent, the reaction is conducted at preferably from 50° C. to 300° C., and more preferably from 100° C. to 250° C., in the atmosphere. The reaction time is preferably from 5 to 60 minutes, and more preferably from 10 to 30 minutes.

To act a silicone resin having low silicone migration property as the resin layer, it is preferred that a curing reaction is advanced as possible such that unreacted silicone component does no remain in the silicone resin. The above reaction temperature and reaction time enable that unreacted silicone component does not remain in a silicone resin, and this is preferred. In the case that a reaction time is longer than the above reaction time or a reaction temperature is higher than the above reaction time, oxidation decomposition of the silicone resin simultaneously occurs and a silicone component having low molecular weight is formed. As a result, there is a possibility that silicone migration property is increased. Advancing the curing reaction such that unreacted silicone component does not remain in the silicone resin is preferred to make releasability after heat treatment good.

Furthermore, as described hereinafter, when a thin glass substrate has been laminated on a silicone resin layer, the silicone resin layer bonds to a surface of a supporting glass substrate by anchor effect, and is further strongly fixed thereto.

### <Application of Glass Sealing Material>

The glass sealing material is applied to the outer side of a peripheral part of a resin layer after or during the formation of the resin layer in the first production method, is applied to a peripheral part (position becoming the outer side of a peripheral part of a resin layer) on a first main surface of a supporting glass substrate before the formation of the resin layer in the second and third production methods, and is applied to the outer side of a peripheral part of the resin layer after closely adhering the resin layer to a first main surface of a thin glass substrate in the fourth production method.

The method of applying the glass sealing material includes a method of moving a dispenser (liquid constant delivery apparatus) along the outer side of a peripheral part of the resin layer, a method of moving the outer side of a peripheral part of the resin layer along a dispenser positionally fixed, and a method of subjecting screen printing by a screen plate corresponding to a shape of the outer side of a peripheral part of the resin layer to a first main surface of a supporting glass substrate.

In the fourth production method, the glass sealing material is applied by a method of moving a dispenser along the outer side of a peripheral part of the resin layer, or a method of moving the outer side of a peripheral part of the resin layer along a dispenser positionally fixed.

### (Firing of Glass Sealing Material)

The firing of the glass sealing material specifically includes firing by a heating furnace and firing with laser irradiation.

In this case, a melting temperature of the glass sealing material is high temperature. Therefore, in the case where the whole glass laminate is in high temperature, deterioration of a resin layer may proceed. For this reason, firing with laser irradiation is selected in the first and fourth production methods in which a resin layer is formed before the firing of the glass sealing material. According to the laser irradiation, only the glass sealing material can locally be heated and fired. Thus, an outer frame layer can be formed by firing the glass sealing material with laser irradiation. On the other hand, in the second production method, a resin layer is not yet formed at the stage of the firing of the glass sealing material. Therefore, the firing by a heating furnace which heats the whole glass laminate can be selected.

The laser source that can be used in the laser irradiation includes laser having an oscillation wavelength region in a range of from 300 nm to 1,500 nm. In this case, the wavelength of the laser may be a wavelength of any region of ultraviolet region, visible region and infrared region. That is, various kinds of lasers such as argon ion, krypton ion, helium-neon, helium-cadmium, ruby, glass, YAG, titanium sapphire, pigment, nitrogen metal vapor, excimer (for example, Xe, Cl, KrF or ArF), free electron and semiconductor can be used. Of those, semiconductor laser in which emission wavelength region is present in the vicinity of near infrared region can preferably be used for the purpose of firing a glass sealing material that can be applied to the present invention.

The output of laser is not restricted so long as firing of the glass sealing material according to the present invention is possible. When the output of laser is small, the glass sealing material can be fired by prolonging treatment time. Laser emitted from an oscillator may directly be used, and light intensity can be increased by collecting laser using a lens. For example, the output of laser is preferably a range of from 2 to 150 W, and more preferably a range of from 5 to 100 W. In the case where the output of laser is less than 2 W, there is a concern that the glass sealing material cannot be melted. On the other hand, where the output exceeds 150 W, cracks, breakage and the like easily occur in a thin glass substrate and a supporting glass substrate.

### (Close Adhesion)

A thin glass substrate and a supporting glass substrate having a resin layer fixed to a first main surface thereof are laminated, and a peelable surface of the resin layer is closely adhered to a first main surface of the thin glass substrate.

The first main surface of the thin glass substrate and the peelable surface of the resin layer are preferably bonded by force due to van der Waals force between solid molecules that are very close and face to each other, that is, with close adhesion force.

Method of laminating a thin glass substrate and a supporting glass substrate having a resin layer fixed to a first main surface thereof is not particularly restricted, and can be carried out using, for example, the conventional methods. Specific example of the method includes a method of laminating a thin glass substrate on a peelable surface of a resin layer under normal pressure environment, and then pressure-bonding the resin layer and the thin glass substrate using a roll, a press or the like. Pressure bonding with a roll or a press is preferred in that the peelable surface of the resin layer is further closely adhered to the first main surface of the thin glass substrate. Furthermore, pressure bonding with a roll or a press is preferred in that gas bubbles incorporated between the peelable surface of the resin layer and the first main surface of the thin glass substrate are easily removed. When pressure bonding is conducted by a vacuum laminating method or a vacuum press method, suppression of incorporation of gas bubbles and securement of close adhesion are more preferably attained. Pressure bonding under vacuum has the advantage that even in the case that fine gas bubbles remain, the gas bubbles do not grow by heating, making it difficult to lead to deformation defects of the thin glass substrate.

In laminating the thin glass substrate and the supporting glass substrate having a resin layer fixed to a first main surface thereof, it is preferred that the first main surface of the thin glass substrate is sufficiently washed, and the lamination is conducted in an environment having high degree of cleanness. Even though foreign matters are incorporated between the peelable surface of the resin layer and the first main surface of the thin glass substrate, the resin layer deforms and the foreign matters do not affect flatness of a second main surface of the thin glass substrate. The higher the degree of cleanness, its flatness is more excellent. Thus, the washing is preferable.

### <Method for Producing Support-attached Panel for Display Device>

Method for producing a support-attached panel for a display device of the present invention includes a step of forming a member for a display device on a second main surface of the thin glass substrate in the laminate of the present invention.

Specifically, for example, a member for a display device is formed on the second main surface of the thin glass substrate in the laminate of the present invention produced as above.

The member for a display device is not particularly restricted, and includes an array in LCD, a color filter, a transparent electrode in OLED, a hole injection layer, a hole transporting layer, a light emitting layer, and an electron transporting layer.

Method for forming a member for a display device is not particularly restricted, and may be the same as the conventional method.

For example, in the case of producing TFT-LCD as a display device, the same steps as the conventionally known various steps may be used such as a step of forming an array on a glass substrate, a step of forming a color filter on a glass substrate, and a step of sticking the glass substrate having an array formed thereon and the glass substrate having a color filter formed thereon (array-color filter sticking step). More specifically, examples of the treatments carried out in those steps include washing with pure water, drying, film formation, resist liquid application, exposure, development, etching and resist removal. Furthermore, steps to be carried out after performing the array-color filter sticking step include a liquid crystal injection step, and a step of sealing the injection port to be carried out after performing the treatment, and treatments carried out in those steps.

Furthermore, for example, in the case of producing OLED as a display device, a step of forming an organic EL structure on a second main surface of a thin glass substrate includes various steps such as a step of forming a transparent electrode, a step of vacuum depositing a hole injection layer, a hole transporting layer, a light emitting layer, an electron transporting layer and the like, and a sealing step. Examples of the treatment carried out in those steps specifically include film formation treatment, vacuum deposition treatment, and adhesion treatment of a sealing plate.

### <Method for Producing Panel for Display Device>

The method for producing a panel for a display device of the present invention includes a peeling step of peeling the thin glass substrate and the supporting glass substrate in the support-attached panel for a display device obtained by the above production method.

The method of peeling the thin glass substrate and the supporting glass substrate is not particularly restricted, and specifically includes a method of peeling by, for example, inserting a sharp blade in an interface between the thin glass substrate and the resin layer to physically destroy the outer frame layer, and blowing a mixed fluid of water and compressed air into the interface between the thin glass substrate and the resin layer.

Preferably, the support-attached panel for a display device is set on a surface plate such that its supporting glass substrate faces upside and the thin glass substrate faces downside, and the thin glass substrate is sucked under vacuum on the surface plate (in the case that supporting glass substrates are laminated on both surfaces, subjected to the operation sequentially). A blade is inserted in the interface between the thin glass substrate and the resin layer in this state. Thereafter, the supporting glass substrate is sucked with plural vacuum suction pads, and the vacuum suction pads are allowed to rise sequentially from around the position of insertion of the blade. Then, an air layer is formed in an interface between the resin layer and the thin glass substrate, this air layer spreads into the whole area of the interface, and the supporting glass substrate having the resin layer fixed thereto can easily be peeled (in the case that supporting substrates are laminated on both surfaces of the support-attached panel for a display device, the peeling step is repeated for each surface).

The supporting glass substrate having the resin layer fixed thereto and the thin glass substrate in the support-attached panel for a display device of the present invention are peeled by this method, and if necessary, further processing is conducted. Thus, the panel for a display device of the present invention can be obtained.

### EXAMPLES

### (Preparation of Glass Sealing Material A)

Tin-phosphate glass frit (softening point: 360° C.) having a composition of SnO: 55.7 mass %, SnO₂: 3.1 mass %, P₂O₅: 32.5 mass %, ZnO: 4.08 mass %, Al₂O₃: 2.3 mass %, and SiO₂: 1.6 mass %, and having an average particle size of 1.5 μm, a zirconium phosphate ((ZrO)₂P₂O₇) powder as a low expansion filler, and a laser absorber having a composition of Fe₂O₃—Cr₂O₃—MnO—Co₂O₃ were provided. The zirconium phosphate powder as a low expansion filler has a particle size distribution of D₁₀ of 3.3 μm, D₅₀ of 3.8 μm, D₉₀ of 4.6 μm, and Dₘₐₓ of 6.5 μm, and has a specific surface area of 1.8 m²/g. The laser absorber has a particle size distribution of D₁₀ of 0.4 μm, D₅₀ of 0.9 μm, D₉₀ of 1.5 μm, and Dₘₐₓ of 2.8 μm, and has a specific surface area of 5.0 m²/g.

67.2 vol % of the tin-phosphate glass fit, 28.4 vol % of the zirconium phosphate powder, and 4.4 vol % of the laser absorber were mixed to prepare a glass sealing material (thermal expansion coefficient α₁ (50 to 250° C.): 71×10⁻⁷/° C.). The total content of the zirconium phosphate power and the laser absorber is 32.8 vol %. 83 mass % of the glass sealing material was mixed with 17 mass % of a vehicle to prepare a sealing material paste. The vehicle is prepared by dissolving nitrocellulose (4 mass %) as a binder component in a solvent (96 mass %) including butyl carbitol acetate.

### (Preparation of Glass Sealing Material B)

Bismuth-phosphate glass fit (softening point: 410° C.) having a composition of Bi₂O₃: 83.2 mass %, B₂O₃: 5.6 mass %, ZnO: 10.7 mass %, and Al₂O₃: 0.5 mass %, and having an average particle size of 1.0 a cordierite powder as a low expansion filler, and a laser absorber having a composition of Fe₂O₃—Cr₂O₃—MnO—Co₂O₃ were provided. The cordierite powder as a low expansion filler has a particle size distribution of D₁₀ of 1.3 μm, D₅₀ of 2.0 μm, D₉₀ of 3.0 μm, and Dₘₐₓ of 4.6 μm, and has a specific surface area of 5.8 m²/g. The laser absorber has a particle size distribution of D₁₀ of 0.4 μm, D₅₀ of 0.9 μm, D₉₀ of 1.5 μm, and Dₘₐₓ of 2.8 μm, and has a specific surface area of 5.0 ₘ2_{/g.}

72.7 vol % of the bismuth-phosphate glass frit, 22.0 vol % of the cordierite powder, and 5.3 vol % of the laser absorber were mixed to prepare a glass sealing material (thermal expansion coefficient α₁ (50 to 250° C.): 73×10⁻⁷/° C.). The total content of the cordierite power and the laser absorber is 27.3 vol %. 80 mass % of the glass sealing material was mixed with 20 mass % of a vehicle to prepare a sealing material paste. The vehicle is prepared by dissolving ethyl cellulose (2.5 mass %) as a binder component in a solvent (97.5 mass %) including terpineol.

### Example 1

First, a supporting glass substrate (AN 100 manufactured by Asahi Glass Co., Ltd.) having a length of 720 mm, a width of 600 mm, a plate thickness of 0.4 mm, and a linear expansion coefficient of 38×10⁻⁷/° C. was washed with pure water and washed with UV to clean its surface.

Next, the glass sealing material A was printed on a peripheral part on a first main surface of the supporting glass substrate in a frame shape having a width W of 0.6 mm by screen printing. Next, the supporting glass substrate was heated at 430° C. for 10 minutes in the atmosphere to calcine the glass sealing material A. The thickness of an outer frame layer was 20 μm. The cross-sectional area S in this case was 1×10⁻² mm².

Next, a mixture of 100 parts by mass of a non-solvent addition reaction type silicone for a release paper (KNS-320A (viscosity: 0.40Pa·s) manufactured by Shin-Etsu Silicone Co., Ltd.) and 2 parts by mass of a platinum catalyst (CAT-PL-56 manufactured by Shin-Etsu Silicone Co., Ltd.) was applied to an inner region of the outer frame layer printed on the first main surface of the supporting glass substrate and calcined, by a screen printing machine so as to contact the inside of the outer frame layer (coated amount: 30 g/m²).

The supporting glass substrate was heated at 180° C. for 30 minutes in the atmosphere to cure the mixture of the non-solvent addition reaction type silicone for a release paper and the platinum catalyst. Thus, a silicone resin layer having a thickness of 20 μm was obtained.

Next, a first main surface (surface at the side contacting a peelable surface of a silicone resin layer later) of a thin glass substrate (AN 100 manufactured by Asahi Glass Co., Ltd.) having a length of 720 mm, a width of 600 mm, a plate thickness of 0.3 mm, and a linear expansion coefficient of 38×10⁻⁷/° C. was washed with pure water and washed with UV to clean the surface. When the thin glass substrate used has a thickness of 0.3 mm, the thin glass substrate can be handled in the same manner as in the conventional manner as a glass substrate. Therefore, the existing production facilities can be utilized, and this is preferred.

After washing the thin glass substrate, the supporting glass substrate and the thin glass substrate were laminated at room temperature by a vacuum press such that a peelable surface of the silicone resin layer of the supporting glass substrate and a first main surface of the thin glass substrate are overlapped. Thus, a glass laminate was obtained.

Subsequently, the glass sealing material A calcined on the first main surface of the supporting glass substrate was irradiated with laser light (semiconductor laser) having wavelength: 940 nm, output: 60 W and spot diameter: 1.6 mm in scanning rate of 10 mm/second to burn the glass sealing material, followed by quenching and solidifying. Thus, an outer frame was formed so as to seal the thin glass substrate and the supporting glass substrate. Processing temperature at the laser irradiation was measured with a radiation thermometer. As a result, the temperature was from 700 to 800° C. In this case, deterioration state was not observed in the silicone resin layer.

Thus, a “glass laminate A” corresponding to the embodiment 1 of the laminate of the present invention was produced.

Next, the glass laminate A was heat-treated at 450° C. for 1 hour in the atmosphere. Regarding a glass laminate A separately provided, the heating temperature was increased from room temperature to 450° C. under reduced pressure (1.0×10⁻⁵ Pa). However, a gas was not generated from the glass laminate A.

Next, the glass laminate A was subjected to the following peeling test, and peelability was evaluated.

### <Peeling Test>

The glass laminate A was set to a surface plate such that the supporting glass substrate faces upside and the thin glass substrate faces downside, and the second main surface of the thin glass substrate was sucked under vacuum on the surface plate.

Next, while holding the state that the second main surface of the thin glass substrate was sucked under vacuum on the surface plate, the position of the outer frame layer formed near the interface between the thin glass substrate and the surrounding glass substrate at the corner of the glass laminate A was recognized by CCD camera. A sharp stainless steel blade was inserted toward the position of the outer frame layer recognized, and the outer frame layer was destroyed by the blade. Thereafter, the blade was inserted toward the interface between the silicone resin layer and the thin glass substrate, and the supporting glass substrate was pulled vertically upside to target by using a space between the thin glass substrate and the silicone resin layer, formed by the insertion as a clue.

The peeling test was conducted to the glass laminate A. As a result, an air layer was formed from a corner in which the stainless steel blade had been inserted, of the interface between the silicone resin layer and the thin glass substrate, this air layer spread into the whole region of the interface, and the supporting glass substrate having the silicone resin layer fixed to the first main surface thereof and the thin glass substrate could easily be peeled. When peeling, the outer frame layer remained in the peripheral part of the supporting glass substrate was self-destroyed with the passage of peeling without destroying the thin glass substrate and the supporting glass substrate.

Furthermore, the residue of the outer frame layer adhered to the first main surface of the thin glass substrate after peeling could easily be removed by scrub cleaning using cerium oxide. The silicone resin layer of the glass laminate A was good, and its edge was not oxidized.

### Example 2

A glass laminate was obtained in the same manners as in Example 1, except that a size of the thin glass substrate (AN 100 manufacture by Asahi Glass Co., Ltd.) was enlarged to a length of 722 mm and a width of 602 mm. Thus, a “glass laminate B” corresponding to the embodiment 3 of the laminate of the present invention, in which a size of the thin glass substrate is larger than a size of the supporting glass substrate was produced.

Next, the glass laminate B was heat-treated at 450° C. for 1 hour in the atmosphere. Regarding a glass laminate B separately provided, the heating temperature was increased from room temperature to 450° C. under reduced pressure (1.0×10⁻⁵ Pa). However, a gas was not generated from the glass laminate B.

The peeling test was conducted to the glass laminate B. As a result, an air layer was formed in the interface between the silicone resin layer and the thin glass substrate from the corner, this air layer spread into the whole region of the interface, and the supporting glass substrate having the silicone resin layer fixed to the first main surface thereof and the thin glass substrate could easily be peeled. Furthermore, the residue of the outer frame layer adhered to the first main surface of the thin glass substrate after peeling could easily be removed by scrub cleaning using cerium oxide. The silicone resin layer of the glass laminate B was good, and its edge was not oxidized.

### Example 3

A glass substrate (AN 100 manufactured by Asahi Glass Co., Ltd.) having a length of 720 mm, a width of 600 mm, a plate thickness of 0.6 mm, and a linear expansion coefficient of 38×10⁻⁷/° C. as a supporting glass substrate was washed with pure water and washed with UV to clean its surface.

Next, a linear polyorganosiloxane having vinyl groups at both terminals (trade name: 8500 manufactured by Arakawa Chemical Industries, Ltd.) and methyl hydrogen polysiloxane having a hydrosilyl group in the molecule (trade name: 12031 manufactured by Arakawa Chemical Industries, Ltd.) were used as resins for forming a resin layer. The resins were mixed with a platinum catalyst (trade name: CAT 12070 manufactured by Arakawa Chemical Industries, Ltd.), and the resulting mixture was diluted with pentane to prepare a mixture having a solid content of 50%. The resulting mixture was applied to the first main surface of the supporting glass substrate by a die coater (coated amount: 40 g/m²) in a size of having a length of 716 mm and a weight of 596 mm. The resulting coating was heat cured at 250° C. for 30 minutes in the atmosphere to form a silicone resin layer having a thickness of 20 μm. The silicone resin layer was formed so as to locate every 2 mm inner from four sides of the first main surface of the supporting glass substrate. The mixing ratio of the linear polyorganosiloxane and the methyl hydrogen polysiloxane was adjusted such that the molar ratio of a hydrosilyl group to the vinyl group is 1/1. The platinum catalyst was added in an amount of 5 parts by mass per 100 parts by mass of the sum of the linear polyorganosiloxane and the methyl hydrogen polysiloxane.

Next, a first main surface (surface at the side contacting a silicone resin layer later) of a glass substrate (AN 100 manufactured by Asahi Glass Co., Ltd.) having a length of 718 mm, a width of 598 mm, a plate thickness of 0.1 mm, and a linear expansion coefficient of 38×10⁻⁷/° C. as a thin glass substrate was washed with pure water and washed with UV to clean the surface. The first main surface of the thin glass substrate was laminated on a peelable surface of the silicone resin layer such that the first main surface projects every 1 mm outside from four sides of the peelable surface of the silicone resin layer, and those were adhered by a vacuum press at room temperature to obtain a glass laminate.

Subsequently, the glass sealing material B was applied to the outer side of a peripheral part of the silicone resin layer using a dispenser having a nozzle tip inner diameter of 50 μm in an application rate of 10 mm/sec such that the silicone resin layer is blocked from the external air. The glass laminate was dried by heating at 120° C. for 10 minutes, and the glass sealing material was irradiated with laser light (semiconductor laser) having a wavelength of 940 nm, an output of from 6 to 10 W, and a spot diameter of 1.6 mm in a scanning rate of 1 mm/second through the supporting glass substrate, thereby firing the glass sealing material, followed by quenching and solidifying, so that an outer frame layer was formed so as to seal the thin glass substrate and the supporting glass substrate. Processing temperature at the laser irradiation was measured with a radiation thermometer. As a result, the temperature was from 600 to 800° C. The cross-sectional area S in this case was 6×10⁻⁴ mm². Thus, a “glass laminate C” corresponding to the embodiment 2 of the laminate of the present invention was produced.

Next, the glass laminate C was heat-treated at 450° C. for 1 hour in the atmosphere. Regarding a glass laminate C separately provided, the heating temperature was increased from room temperature to 450° C. under reduced pressure (1.0×10⁻⁵ Pa). However, a gas was not generated from the glass laminate C.

The peeling test was conducted to the glass laminate C. As a result, an air layer was formed from the corner in which a stainless steel blade was inserted, of the interface between the silicone resin layer and the thin glass substrate, this air layer spread, and the supporting glass substrate having the silicone resin layer fixed to the first main surface thereof and the thin glass substrate could easily be peeled. Furthermore, the residue of the outer frame layer adhered to the first main surface of the thin glass substrate after peeling could easily be removed by scrub cleaning using cerium oxide. The silicone resin layer of the glass laminate C was good, and its edge was not oxidized.

### Example 4

A glass laminate before formation of an outer frame layer was prepared using the same method as in Example 3, except for changing a size and a thickness of the supporting glass substrate and thin glass substrate used as follows.

A glass substrate (AN 100 manufactured by Asahi Glass Co., Ltd.) having a length of 740 mm, a width of 620 mm, a plate thickness of 0.5 mm, and a linear expansion coefficient of 38×10⁻⁷/° C. was used as the supporting glass substrate.

A glass substrate (AN 100 manufactured by Asahi Glass Co., Ltd.) having a length of 740 mm, a width of 620 mm, a plate thickness of 0.2 mm, and a linear expansion coefficient of 38×10⁻⁷/° C. was used as the thin glass substrate.

Each side of the glass laminate obtained was cut with a width of 10 mm from the outer edge. The cutting method was that a cutting line was drawn by a wheel on the same position of the respective second main surfaces of the thin glass substrate and the supporting glass substrate, and cutting was performed by adding a pulling force to the outer side in an in-plane direction of the glass laminate. Thereafter, the cut surface of the glass laminate was chamfered into R shape (arc shape) using a grinding stone, and the glass laminate surface was washed using an alkali detergent.

Thereafter, the portion in which the resin layer of a peripheral part of the glass laminate edge was exposed was sealed with a glass sealing material using the same method as in Example 3. The width of the outer frame layer in this case was 0.05 mm. Thus, a “glass laminate D” corresponding to the embodiment 5 of the laminate of the present invention was produced.

Next, the glass laminate D was heat-treated at 450° C. for 1 hour in the atmosphere. Regarding a glass laminate D separately provided, the heating temperature was increased from room temperature to 450° C. under reduced pressure (1.0×10⁻⁵ Pa). However, a gas was not generated from the glass laminate D.

The peeling test was conducted to the glass laminate D. As a result, an air layer was formed from the corner in which a stainless steel blade was inserted, of the interface between the silicone resin layer and the thin glass substrate, this air layer spread into the whole region of the interface, and the supporting glass substrate having the silicone resin layer fixed to the first main surface thereof and the thin glass substrate could easily be peeled. Furthermore, the residue of the outer frame layer adhered to the first main surface of the thin glass substrate after peeling could easily be removed by scrub cleaning using cerium oxide. The silicone resin layer of the glass laminate D was good, and its edge was not oxidized.

### Example 5

In this Example, LCD is produced using the glass laminate C obtained in Example 3. Two glass laminates C (C1 & C2) are provided, and the glass laminate C1 is subjected to an array formation step to form an array on a second main surface of a thin glass substrate. The other glass laminate C2 is subjected to a color filter formation step to form a color filter on a second main surface of the thin glass substrate. The glass laminate C1 and the glass laminate C2 are laminated facing an array-formed surface of the glass laminate C1 and a color filter-formed surface of the glass laminate C2 to obtain an empty cell. Subsequently, the second main surface of the supporting glass substrate of the glass laminate C1 is sucked under vacuum to the surface plate, and a stainless steel blade having a thickness of 0.1 mm is inserted toward the corner of the outer frame layer of the glass laminate C2 to physically destroy the outer frame layer at the corner. Thereafter, the blade is inserted in the interface between the thin glass substrate and the resin layer to give a trigger of peeling between the first main surface of the thin glass substrate and the peelable surface of the resin layer. The second main surface of the supporting glass substrate of the glass laminate C2 is sucked with 24 vacuum suction pads, and then sequentially elevated from the suction pad near the corner of the glass laminate C2. As a result, only an empty cell of LCD having the supporting glass substrate attached thereto of the glass laminate C1 remains on the surface plate, and the supporting glass substrate having the resin layer of the glass laminate C2 fixed to the first main surface thereof can be peeled.

Next, the second main surface of the thin glass substrate having a color filter formed on the first surface thereof is sucked under vacuum to the surface plate, a stainless steel blade having a thickness of 0.1 mm is inserted toward the corner of the outer frame layer of the glass laminate C1 to physically destroy the outer frame layer at the corner, similar to the above. Thereafter, a trigger of peeling between the first main surface of the thin glass substrate and the peelable surface of the resin layer is given. The second main surface of the supporting glass substrate of the glass laminate C1 is sucked with 24 vacuum suction pads, and then sequentially elevated from the suction pad near the corner of the glass laminate C1. As a result, only an empty cell of LCD remains on the surface plate, and the supporting glass substrate having the resin layer fixed to the first main surface thereof can be peeled. Thus, an empty cell of LCD constituted of the thin glass substrate having a thickness of 0.1 mm is obtained.

Subsequently, the thin glass substrate is cut to divide into 168 empty cells each having 51 mm length×38 mm width, and a liquid crystal injection step and a sealing step of an injection port are carried out to the cells, thereby forming liquid crystal cells. A step of adhering a polarizing plate to the liquid crystal cells formed is carried out, and a module formation step is then carried out, thereby obtaining LCD. The LCD thus obtained does not have problem on characteristics.

### Example 6

In this Example, LCD is produced using the glass laminate A obtained in Example 1. Two glass laminates A1 and A2 are provided, and the glass laminate Al is subjected to an array formation step to form an array on a second main surface of a thin glass substrate. The other glass laminate A2 is subjected to a color filter formation step to form a color filter on a second main surface of the thin glass substrate. The glass laminate A1 and the glass laminate A2 are laminated facing an array-formed surface of the glass laminate A1 and a color filer-formed surface of the glass laminate A2. Thereafter, the respective supporting substrates of the glass laminates A1 and A2 are peeled in the same manner as in Example 5 to obtain an empty dell of LCD. Scratches leading to decrease in strength are not observed on the first main surface of the thin glass substrate after peeling.

Subsequently, the respective thin glass substrates of the empty cells of LCD are subjected to chemical etching treatment to decrease the respective thicknesses from 0.3 mm to 0.15 mm. Occurrence of etchpits optically leading to the problem is not observed on the first main surface of the thin glass substrate after the chemical etching treatment.

Thereafter, the thin glass substrate is cut to divide into 168 empty cells each having 51 mm length×38 mm width, and a liquid crystal injection step and a sealing step of an injection port are carried out to the cells, thereby forming liquid crystal cells. A step of adhering a polarizing plate to the liquid crystal cells formed is carried out, and a module formation step is then carried out, thereby obtaining LCD. The LCD thus obtained does not have problem on characteristics.

### Example 7

In Example 7, OLED is produced using the glass laminate D obtained in Example 4.

Organic EL structure is formed on the second main surface of the thin glass substrate of the glass laminate D by subjecting the glass laminate D to a step of forming a transparent electrode, a step of forming an auxiliary electrode, a step of depositing a hole injection layer, a hole transporting layer, a light emitting layer, an electron transporting layer and the like, and a step of sealing those. Next, the supporting glass substrate of the glass laminate D is peeled from the thin glass substrate in the same manner as in Example 5. Scratches leading to decrease in strength are not observed on the first main surface of the thin glass substrate after peeling.

Subsequently, the thin glass substrate is cut using a laser cutter or a scribe-break method to divide into 288 cells each having 41 mm length×30 mm width, and a module formation step is then carried out to prepare OLED. The OLED thus obtained does no have the problem on characteristics.

### Comparative Example 1

A glass laminate having the same constitution was provided, except that an outer frame layer is not formed, and the same test as in Example 1 was conducted. A glass laminate X according to Comparative Example 1 was that gas bubbles were not generated, a peelable surface of the silicone resin layer and the first main surface of the thin glass substrate were closely adhered, convex defects were not observed, and smoothness was good.

Next, the glass laminate X was heat-treated at 450° C. for 1 hour in the atmosphere. As a result, the silicone resin layer was oxidized and whitened in an area of about 5 mm from the edge thereof In the case where the whitening occurs, a silica powder may scatter from the glass substrate, leading to contamination of a display device production line. A glass laminate X separately provided was heated from room temperature to 450° C. under reduced pressure (1.0×10⁻⁵ Pa). As a result, occurrence of a decomposition product of the silicone resin layer was observed around the temperature exceeding 430° C.

Although the present invention has been described in detail and by reference to the specific embodiments, it is apparent to one skilled in the art that various modifications or changes can be made without departing the spirit and scope of the present invention.

This application is based on Japanese Patent Application No. 2009-241384 filed on Oct. 20, 2009, the disclosure of which is incorporated herein by reference.

### INDUSTRIAL APPLICABILITY

According to the present invention, a glass laminate in which a resin layer is difficult to be oxidized even in high temperature heat treatment can be provided.

### DESCRIPTION OF REFERENCE NUMERALS AND SIGNS

10, 20, 30, 40, 50: Laminate

12, 22, 32, 42, 52: Thin glass substrate

14, 24, 34, 44, 54: Resin layer

16, 26, 36, 46, 56: Outer frame layer

18, 28, 38, 48, 58: Supporting glass substrate

1. A glass laminate comprising:
a thin glass substrate having a first main surface and a second main surface;
a supporting glass substrate having a first main surface and a second main surface, provided such that the first main surface thereof faces the first main surface of the thin glass substrate;
a resin layer formed between the thin glass substrate and the supporting glass substrate, fixed to the first main surface of the supporting glass substrate and closely adhered to the first main surface of the thin glass substrate with peelability to the first main surface thereof; and
an outer frame layer containing a glass sealing material and being formed by firing at an outer side of a peripheral part of the resin layer.

2. The glass laminate according to claim 1, wherein the outer frame layer is formed by firing with laser irradiation.

3. The glass laminate according to claim 2, wherein the glass sealing material has a melting temperature of 400° C. or more and 750° C. or less.

4. The glass laminate according to claim 1, wherein the outer frame layer has a cross-sectional area S of 3×10⁻⁶ mm²≦S≦5 mm².

5. The glass laminate according to claim 1, wherein the resin layer contains at least one kind selected from the group consisting of an acrylic resin, a polyolefin resin, a polyurethane resin and a silicone resin.

6. The glass laminate according to claim 1, wherein the thin glass substrate has a thickness of 0.3 mm or less, and the supporting glass substrate has a thickness of 0.4 mm or more.

7. A support-attached panel for a display device, comprising: the glass laminate according to claim 1, and a member for a display device, formed on the second main surface of the thin glass substrate in the glass laminate.

8. A panel for a display device, obtained from the support-attached panel for a display device according to claim 7.

9. A display device comprising the panel for a display device according to claim 8.

10. A method for producing the glass laminate according to claim 1, the method comprising the steps of:
forming the resin layer on the first main surface of the supporting glass substrate and fixing the resin layer to the first main surface of the supporting glass substrate;
applying the glass sealing material to the outer side of the peripheral part of the resin layer fixed to the first main surface of the supporting glass substrate;
closely adhering a peelable surface of the resin surface fixed to the first main surface of the supporting glass substrate to the first main surface of the thin glass substrate; and
firing the glass sealing material applied to the outer side of the peripheral part of the resin layer to form the outer frame layer.

11. A method for producing the glass laminate according to claim 1, the method comprising the steps of:
applying the glass sealing material to a peripheral part on the first main surface of the supporting glass substrate;
firing the glass sealing material applied to the peripheral part of the first main surface of the supporting glass substrate to form the outer frame layer;
forming the resin layer in an inner region of the outer frame layer formed on the first main surface of the supporting substrate, and fixing the resin layer to the first main surface of the supporting glass substrate; and
closely adhering a peelable surface of the resin layer fixed to the first main surface of the supporting glass substrate to the first main surface of the thin glass substrate.

12. A method for producing the glass laminate according to claim 1, the method comprising the steps of:
applying the glass sealing material to a peripheral part on the first main surface of the supporting glass substrate;
forming the resin layer in an inner region of the glass sealing material applied to the first main surface of the supporting glass substrate and fixing the resin layer to the first main surface of the supporting glass substrate;
firing the glass sealing material applied to the first main surface of the supporting glass substrate to form the outer frame layer; and
closely adhering a peelable surface of the resin layer fixed to the first main surface of the supporting glass substrate to the first main surface of the thin glass substrate.

13. A method for producing the glass laminate according to claim 1, the method comprising the steps of:
forming the resin layer on the first main surface of the supporting glass substrate and fixing the resin layer to the first main surface of the supporting glass substrate;
closely adhering a peelable surface of the resin layer to the first main surface of the thin glass substrate;
applying the glass sealing material to the outer side of the peripheral part of the resin layer; and
firing the glass sealing material applied to the outer side of the peripheral part of the resin layer to form the outer frame layer.

14. The method for producing the glass laminate according to claim 13, wherein the outer frame layer is formed by irradiating the glass sealing material with laser.

15. A method for producing a supported-attached panel for a display device, the method comprising:
the method for producing a glass laminate according to claim 10; and
a step of forming a member for a display device on the second main surface of the thin glass substrate of the glass laminate.

16. A method for producing a panel for a display device, the method comprising:
the method for producing a support-attached panel for a display device according claim 15; and
a peeling step of peeling the thin glass substrate and the supporting glass substrate of the support-attached panel for a display device.

17. The method for producing a panel for a display device according to claim 16, wherein the peeling step is a step of peeling the thin glass substrate and the supporting glass substrate after physically destroying at least a part of the outer frame layer.
